(19) United States
(12) Patent Application Publication
(10) Pub. No.: US 2004/0216494 A1
(43) Pub. Date: Nov. 4, 2004

(54) Burner for combustion or flame hydrolysis, and combustion furnace and process

(76) Inventor: Shinichi Kurotani, Nakakubiki-gun (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/857,880

(22) Filed: Jun. 2, 2004

Related U.S. Application Data
(62) Division of application No. 09/646,536, filed on Sep. 19, 2000.
Application No. 09/646,536 is a 371 of international application No. PCT/JP99/01821, filed on Apr. 6, 1999.

(51) Int. Cl. C03B 37/018

(52) U.S. Cl. 65/531

(57) ABSTRACT

A burner which prevents obstruction by combustion products has a circularly concentric multi-tube construction of three or more tubes, comprising a central tube which emits a liquid containing a chemical element that forms a solid oxide by combustion or flame hydrolysis, a first outer tube disposed concentrically outside the central tube for emitting a combustion-supporting gas and/or a non-combustible gas, a second outer tube disposed concentrically outside the first outer tube for emitting a combustion-supporting gas and/or a non-combustible gas, and optionally, a passage disposed outside the second outer tube for supplying a combustion-supporting gas and/or a non-combustible gas. The liquid emitted from the central tube is atomized and burned by the combustion-supporting gases and/or non-combustible gases supplied from the outer tubes and the optional passage disposed outside thereof. The flame thereby generated is covered by the combustion-supporting gases and/or non-combustible gases supplied from the outer tubes and the optional passage disposed outside thereof.

This application is a divisional application of U.S. application Ser. No. 09/646,536, filed 19 Sep. 2000, which is a national phase under 35 U.S.C. § 371 of PCT International Application No. PCT/JP99/01821 which has an International filing date of Apr. 6, 1999, which designated the United States of America, the entire contents of which are hereby incorporated by reference.

### TECHNICAL FIELD

The present invention relates to a burner which, when used to atomize and burn or flame-hydrolyze a liquid containing a chemical element that forms a solid oxide by combustion or flame hydrolysis, discourages the deposition and buildup of solid oxide on the burner proper, in the burner vicinity and at the interior of the furnace in which combustion takes place, by virtue of which the burner is capable of stable and continuous long-term operation and can efficiently burn or flame-hydrolyze the liquid. The invention also relates to a combustion furnace equipped with this burner, and to a process for burning such a liquid using the same burner.

### BACKGROUND ART

Known processes for burning combustible liquids include methods in which the combustible liquid is either rendered by a variety of techniques into a mist-like mixture of liquid droplets and gas or vaporized, then is delivered to an incinerator and burned; and methods in which the combustible liquid is mixed with a solid such as sludge, sand or assorted debris, and burned.

The combustion method involving vaporization with a vaporizing burner is applicable to fuels having a boiling point lower than the thermal decomposition temperature, such as distillate oils (e.g., gasoline, kerosene, gas oil). However, when applied to liquid fuels having a thermal decomposition temperature lower than the boiling point, such as residual oils (e.g., heavy oils, tar), this method gives rise to carbon deposition and other undesirable effects on account of thermal decomposition. Combustion involving mixture of the combustible liquid with a solid material also has numerous limitations, including the requirement that the liquid and the solid material form a non-reactive, chemically stable combination.

As a result, in those cases where the combustible liquid to be burned contains a chemical element from group 1A other than hydrogen, group 2A, group 3B, group 4B, group 5B, group 6B, group 7B, group 8, group 1B, group 2B, group 3A, group 4A other than carbon, group 5A other than nitrogen, or group 6A other than oxygen and sulfur (which elements are collectively referred to hereinafter as the “S element”) of the CAS version of the periodic table of the elements (see F. Albert Cotton and Geoffery Wilkinson: Advanced Inorganic Chemistry (John Wiley & Sons, Inc., 1988), back cover), and in cases where the combustible liquid contains high-boiling compounds, inorganic salts or the like, use is commonly made of a method in which the combustible liquid is atomized and burned. Atomizing techniques known to be used in such cases include mechanical atomization, rotary atomization, twin-fluid atomization, high-intensity combustion and radiant combustion.

There are known to be reactions whereby, when an S element-containing compound is burned or hydrolyzed in a flame, the S element oxidizes to form an oxide fine powder. Examples of the industrial application of this principle include methods for producing synthetic quartz glass and metal oxide powders. These are familiar as flame hydrolysis processes.

When a combustible liquid containing the above-described S element-containing compound (referred to hereinafter as an “S liquid”) is burned, undesirable effects such as those listed below arise due to the formation of the S element oxide. These effects are especially striking when the concentration of S element-containing compound is high.

(1) A powder of the S element oxide readily deposits and builds up on the burner and on furnace walls near the burner.

(2) The deposited S element oxide tends to melt and solidify under exposure to the elevated temperatures near the burner.

(3) The deposited and built-up, or melted and solidified, S element oxide alters the shape of the burner and its vicinity and blocks the burner opening, destroying flame stability and even, in the worst case, extinguishing the flame.

Measures that are used to avoid such effects include diluting the S liquid so as to lower the concentration of S element oxide in the combustion gas, and changing the type of burner or the atomization technique.

However, the above dilution approach is ineffective unless the concentration of S element-containing compound is greatly reduced. Unfortunately, this has the drawback of lowering the throughput of the S liquid, in addition to which treatment cannot be carried without the use of some other waste product or fuel as the diluting agent.

There is also combustion technology designed specifically for compounds that form solids when burned. For example, a number of combustion processes and apparatuses which are targeted at the use of special material gases such as the silanes, arsines and phosphines in waste gases discharged from semiconductor fabrication equipment, and have a construction that prevents the deposition of combustion products in the vicinity of the burner, are known to the art (see JP-A 59-279014, JP-B 62-134414 and JP-B 1-95214) and have been furnished for practical use. Unfortunately, all this technology is targeted at the treatment of substances which are gases, and so the following drawbacks are encountered when these known processes are used to burn S liquids.

(1) Because the S liquid must be supplied as a vapor, the process is accompanied by some type of vaporizing operation such as heating or pressure reduction. The work is thus more involved and the system more complex and less cost-effective.

(2) Treatment is impossible when the thermal decomposition point is lower than the boiling point or the S liquid contains a nonvolatile substance.

(3) The concentration of S element oxide fine particles within the furnace interior space or the flame must be held to a low level, resulting in a low throughput for the apparatus.

In cases where the S liquid is directly atomized and burned in the combustion space, merely using a liquid burner manufactured according to the known gas burner construction or principle described above results in the deposition and buildup of fine particles of S element oxide on the burner proper or in the burner vicinity, making it difficult to carry out combustion with long-term stability. The reason is that the S element oxide fine particle concentration within the furnace interior space or the flame differs markedly between the above-described known burner technology for burning gases and burners for burning liquids. Specifically, this concentration is much higher in burners for burning liquids.

That is, there do not currently exist practical combustion apparatuses and processes which are capable, by virtue of modifications in the burner design and the method of atomization, of the continuous combustion with long-term stability of liquids which form solids such as S element oxides using a burner capable of burning such liquids while inhibiting the deposition of such solid products.

In light of these circumstances, it has been necessary to adopt, in devices for burning S liquids, a method wherein use is made of a burner similar to common burners which burn other combustible liquids and combustion is stopped temporarily to either periodically clean off the S element oxide that has built up on the burner itself or in the burner vicinity or to replace the burner, following which the system is re-ignited and combustion is continued.

Various types of combustion furnaces may be used to burn S element-containing liquids, including stoker furnaces, fixed-bed furnaces, rotary-hearth furnaces, multiple-hearth furnaces, rotary kilns, fluidized-bed furnaces and vertical cylindrical furnaces. The appropriate type of furnace is selected according to the presence or absence of solids and gases which burn at the same time, as well as the properties and amounts thereof.

However, when an S element which elicits a reaction that forms the above-described type of oxide fine powder is present in a high concentration, these known types of combustion furnaces have the following drawbacks.

(1) the S element oxide readily deposits and builds up on the inside walls of the furnace.

(2) The deposited S element oxide is exposed to elevated temperatures within the furnace, and thus readily melts and solidifies.

(3) The deposited and built-up, or melted and solidified, S element oxide alters the shape of the furnace interior, blocks the opening, and even, in the worst case, extinguishes the flame.

Hence, when the above-described S element-containing liquid is burned in a prior-art combustion furnace, as noted above in connection with prior-art burners, the method hitherto used has involved temporarily stopping combustion to periodically clean off the S element oxide that has deposited, built up and solidified within the furnace and remove the oxide from the furnace, then re-igniting the furnace and continuing combustion.

This can be illustrated with a specific example wherein a liquid containing a silicon compound (referred to hereinafter as a “silicon liquid”) is burned in a vertical cylindrical furnace equipped with an external-mixing burner comprising a central tube having a pressure atomizing configuration, an outer tube which concentrically surrounds the central tube and supplies air or oxygen, and a flame holder situated in front of the central tube (which burner is referred to hereinafter as a “double-tube burner”). In this case, the silicon dioxide powder begins to deposit onto the surface of the flame holder and the inside walls of the furnace about 1 to 2 hours after the start of combustion. The thickness of the powder deposits gradually increases and the powder sinters, forming a hard, porous vitreous substance. The vitreous substance stops good atomization from occurring, reduces the volume of the combustion chamber and changes the shape of the chamber, resulting in a loss in flame stability. In the worst case, this may lead to obstruction of the burner discharge orifices or the combustion chamber and flame failure.

To deal with this situation in actual furnace operation, it is necessary, for example, to temporarily halt combustion about once every 4 to 8 hours by stopping the supply of silicon liquid and air or oxygen, and draw the burner out of the furnace to be cleaned or replaced with another burner that has been readied for use. Alternatively, every 1 to 2 days, combustion may have to be halted and the furnace interior cooled, then opened to break up and remove vitreous silicon dioxide that has deposited, built up and solidified at the interior. The burner is then re-ignited and combustion is continued. Such a process is highly laborious.

Reducing the frequency of such cleaning calls not only for a change in the combustion conditions, such as the ratio of combustion-supporting gases (e.g., air, oxygen) and the feed rate of silicon liquid, but also for lowering the concentration of the silicon-containing compound within the silicon liquid by using a liquid capable of dilution or admixture with the silicon liquid (e.g., toluene, xylene, kerosene) to dilute or mix with the silicon liquid or, alternatively, for lowering the concentration of silicon-containing compound within the substance being burned by burning at the same time a solid material such as sludge, assorted debris or sawdust. A sufficient concentration lowering effect requires, as noted above, that the concentration of the silicon-containing compound be set very low. The result is an increase in dilution-related work and in the amount of material fed to the process, and a decline in the capacity to burn silicon liquid. Clearly, this is not an economically desirable approach.

### DISCLOSURE OF THE INVENTION

It is therefore an object of the present invention to provide a burner for atomizing and burning S liquid, which discourages the deposition and buildup of S element oxides on the burner proper and in the burner vicinity, by virtue of which the burner is capable of stable and continuous long-term operation and can efficiently burn or flame-hydrolyze combustible liquids such as liquid waste products containing S element-containing compounds. Another object of the invention is to provide a combustion furnace equipped with the same burner and a process for burning the foregoing liquid using the same burner.

To attain the above objects, the invention provides the burner, combustion furnace and combustion processes described below.

### Burner

A burner which prevents obstruction by combustion products and has a circularly concentric multi-tube construction of three or more tubes is characterized by comprising:

a central tube which emits a liquid containing a chemical element that forms a solid oxide by combustion or flame hydrolysis,

a first outer tube which is disposed concentrically outside the central tube and emits a combustion-supporting gas and/or a non-combustible gas,

a second outer tube which is disposed concentrically outside the first outer tube and emits a combustion-supporting gas and/or a non-combustible gas, and optionally,

a passage which is disposed outside the second outer tube and supplies a combustion-supporting gas and/or a non-combustible gas;

wherein the liquid emitted from the central tube is atomized and burned by the combustion-supporting gases and/or non-combustible gases supplied from the outer tubes and the optional passage disposed outside thereof, and the flame thereby generated is covered by the combustion-supporting gases and/or non-combustible gases supplied from the outer tubes and the optional passage disposed outside thereof.

According to a preferred embodiment of the burner, the chemical element that forms a solid oxide by combustion or flame hydrolysis is silicon, the velocity of liquid emission from the central tube is 5 to 250 m/s, the velocity of gas emission from the first outer tube is 1 to 250 m/s, the velocity of gas emission from the second outer tube is 1 to 250 m/s, a burner tile is provided outside of the second outer tube, and the amount of combustion-supporting gases relative to the substance being burned is 0.5 to 5.0 times the stoichiometric amount.

### Combustion Furnace

A combustion furnace is characterized by comprising the above-described burner, a mechanism which holds the surface temperature on an inside wall of the furnace or the surface temperature of solid oxide deposits on the furnace inside wall lower than the melting point or sticking temperature of the solid oxide, and/or a mechanism which can remove solid oxide deposits from the inside wall of the furnace.

According to a preferred embodiment of the combustion furnace, the chemical element that forms a solid oxide by combustion or flame hydrolysis is silicon; the burner is configured such that the central tube has an atomizing mechanism at the tip thereof, each outer tube concentrically surrounding the central tube has a tip that is either coplanar with the tip of the central tube or projects forward therefrom and, if necessary, a flame holder is disposed in front of the central tube; and the velocity of liquid emission from the central tube is 5 to 250 m/s, the velocity of gas emission from the first and second outer tubes is 1 to 250 m/s, and the amount of combustion-supporting gases relative to the substance being burned is 0.5 to 5.0 times the stoichiometric amount.

Preferably, the combustion furnace additionally has a mechanism that holds the surface temperature on the inside wall of the furnace at from 200 to 1,000° C. and/or a mechanism that can remove solid oxide deposits from the inside wall of the furnace.

### Combustion Process

First Embodiment:

A combustion process for atomizing and burning or flame-hydrolyzing within a combustion furnace a liquid containing a chemical element that forms a solid oxide by combustion or flame hydrolysis is characterized in that the process uses the above-described burner and involves emitting the liquid from the central tube, carrying out combustion with the combustion-supporting gases and/or non-combustible gases emitted from the concentric outer tubes disposed outside the central tube and also emitted from the optional passage disposed outside the outer tubes; and covering the flame thereby generated with the combustion-supporting gases and/or non-combustible gases supplied from the outer tubes and also supplied from the optional passage disposed outside the outer tubes.

Second Embodiment:

A combustion process for atomizing and burning or flame hydrolyzing within a combustion furnace a liquid containing a chemical element that forms a solid oxide by combustion or flame hydrolysis is characterized in that the process involves emitting the liquid from a central tube, carrying out atomization and combustion with combustion-supporting gases and/or non-combustible gases emitted from outer tubes provided with circular concentricity outside the central tube and also emitted from an optional passage provided outside the outer tubes, covering the flame thereby generated with the combustion-supporting gases and/or non-combustible gases supplied from the outer tubes and also supplied from the optional passage provided outside the outer tubes, and carrying out treatment to hold the surface temperature at an inside wall of the combustion furnace below the melting point or sticking temperature of the solid oxide and/or carrying out treatment to remove solid oxide deposits from the inside wall of the furnace.

Preferably, in this second embodiment, the chemical element that forms a solid oxide by combustion or flame hydrolysis is silicon, and the surface temperature on the inside wall of the furnace or the surface temperature of solid oxide deposits on the furnace inside wall is held at from 200 to 1,000° C.

As noted above, the burner of the invention has a flame-generating burner main body with a multi-tube construction. The flame formed by atomization of a liquid containing the above-described S element-containing compound is covered from the outside with a combustion-supporting gas such as air or oxygen or with a non-combustible gas such as nitrogen containing the combustion-supporting gases so as to keep combustion gases present in the furnace from passing through and mixing with the flame. This arrangement limits entrainment of the S element oxide formed in the flame by the externally circulating flow that arises due to combustion, making it possible to prevent the S element oxide from approaching the burner and its vicinity. Because the above arrangement also serves to keep the edge of the internally circulating flow away from the tips of the multi-tube construction, S element oxide that has been entrained by the internally circulating flow can also be prevented from approaching the burner and its vicinity. As a result, S element oxide that forms from combustion or flame hydrolysis of the above-described liquid can be prevented from depositing and building up, or melting and solidifying, on or near the burner.

For example, the burner according to the above preferred embodiment atomizes and burns as fine droplets the S liquid emitted from the central tube with a combustion-supporting gas such as air or oxygen emitted from the first outer tube. The flame that emerges at that time is covered by a combustion-supporting gas such as air or oxygen, or a non-combustible gas containing the combustion-supporting gas, that has been emitted from the second or a subsequent outer tube. By additionally passing a combustion-supporting gas such as air or oxygen or a non-combustible gas through a gap between the second or subsequent outer tube and a burner tile disposed on the outside thereof, the overall flame is effectively covered by gas streams. Because the flame is covered by the combustion-supporting gas such as air or oxygen, or the non-combustible gas such as nitrogen, that has been emitted from the gap between the second or subsequent outer tube and the burner tile, the flame is shielded from circulation and mixture with combustion gases present within the combustion furnace. Thus, most of the S element oxide formed in the flame is discharged into the furnace by the flame jet, so that entrainment by the externally circulating flow is suppressed, making it possible to greatly dilute the concentration of S element oxide in the externally circulating flow and internally circulating flow. These principles serve to minimize the concentration of S element oxides within gases near the burner main body and near the furnace walls in the burner vicinity, effectively suppressing deposition onto the solid wall surfaces. Furthermore, because the vicinity of the central tube tip is covered with a stream of air, oxygen, nitrogen or the like emitted from a second or subsequent outer tube, the small amount of S element oxide that has been entrained by the internally circulating flow never reaches the vicinity of the atomizing orifice on the central tube, making it possible to prevent deposition of the S element oxide.

The inventive burner thus resists the deposition and build up of S element oxides on the burner itself and in its vicinity, enabling stable and continuous operation for an extended period of time, and in turn making it possible to efficiently burn liquids such as waste products containing S element-bearing compounds.

Moreover, by using the above-described burner in the combustion furnace of the invention, as noted above, the concentration of S element oxides in gases near the burner itself and near the furnace walls in the burner vicinity is minimized, effectively suppressing deposition on solid wall surfaces. Also, when the furnace is equipped with a flame holder, the small amount of S element oxide entrained by the internally circulating flow lightly deposits on the surface of the flame holder and never reaches the vicinity of the atomizing orifice at the tip portion of the central tube positioned behind the flame holder, and so no change occurs in the atomizing state, making it possible to maintain good atomization. Moreover, given that the S element oxide which has deposited on the surface of the flame holder is cooled by the combustion-supporting gas such as air or oxygen or the non-combustible gas such as nitrogen that is emitted from the first outer tube, it does not reach a temperature at which melting and solidification take place. Hence, the deposits thicken while remaining in the form of a powder, and stable combustion is not hindered by the flaking off of vitrified deposits.

The combustion furnace according to the above-described preferred embodiment has a mechanism which holds the temperature of the furnace inside walls lower than the temperature at which the S element oxide fuses or sticks, preventing the melting and solidification of any S element oxide powder formed by combustion that has deposited on the inside walls, and keeping such deposits in an easy-to-remove state. In addition, the above furnace also has a mechanism for removing powder deposits from the wall surface and enabling such deposits to be taken out of the combustion system. This makes it possible to prevent the buildup of S element oxide powder on the inside walls of the furnace, so that stable and continuous combustion can be achieved.

A specific example of an effective mechanism for holding the temperature on the inside walls of the furnace within a required range is a method that involves spraying water within the combustion chamber. Other suitable methods that may be used for this purpose include cooling the walls by means of coolant circulation in a water-cooled wall construction, for example; and supplying cooling air.

Effective methods for removing powder from the inside walls of the furnace include the installation of a movable scraper or soot blowers within the furnace.

Accordingly, the combustion furnace of the invention discourages the deposition and buildup of solid oxides on or in the vicinity of the burner, is able to maintain solid oxides which deposit on the furnace inside walls in an easy-to-remove state that enables such deposits to be taken out of the system, and can efficiently burn liquids such as S element-containing waste products.

That is, as noted above, every type of burner and combustion furnace that has been used to date for burning combustible liquids, regardless of differences in the particular techniques employed, has been designed and developed for fuels, such as fuel oils (e.g., kerosene, heavy oils), which generate little or no solids from combustion, other than soot from incomplete combustion and products originating from trace amounts of inadvertent impurities in the fuel. Hence, such prior-art burners and combustion furnaces are not adapted for burning substances such as S liquids that generate a large amount (depending on the composition of the S liquid, at least 50% by weight of the material burned) of solids by combustion or flame hydrolysis.

To cite a specific example, when silicon liquid is burned using a double-tube burner and a vertical cylindrical furnace like those described above, silicon dioxide formed in the flame is entrained by the externally recirculating flow that arises near the flame and the internally recirculating flow that arises at the flame interior, and readily approaches the solid wall that extends from the vicinity of the burner discharge orifices to the furnace interior. Because the silicon dioxide formed by combustion at this time has strong cohesive and adhesive forces, it readily deposits and builds up on solid wall surfaces. In addition, the burner vicinity and the furnace walls are exposed to elevated temperatures due to the influence of radiant heat, for example, causing the silicon dioxide powder to sinter, melt and solidify, often forming hard, porous, and strongly adhering vitreous deposits.

Even in cases where use is made of a burner that employs another type of atomization, such as rotary or pressure atomization, entrainment of the silicon dioxide by the externally recirculating flow and the internally recirculating flow occurs in much the same way as in a double-tube burner, resulting in the deposition and buildup or fast adherence of silicon dioxide to the burner and solid walls extending from the burner vicinity to the furnace interior.

Also, regardless of which combustion technique is employed, it is common to place a flame holder on the furnace interior side in front of the burner discharge orifice or to position a burner tile so as to surround the burner within the furnace. However, because the edge of the internally recirculating flow passes through an area very close to the flame holder or burner tile, even if the discharge orifice is protected, silicon dioxide deposition and buildup or melting and solidification end up occurring on the flame holder or burner tile. Nor has it been possible in this way to prevent silicon dioxide deposition on the interior walls of the furnace.

By contrast, when a combustible liquid containing a silicon-bearing compound is burned using the burner of the present invention, no silicon dioxide deposition and buildup whatsoever occurs on the burner even after 1,000 hours have elapsed following the start of combustion, enabling combustion to be continued with full stability. This eliminates both the need to temporarily halt combustion for cleaning and the labor involved in dilution to lower the frequency of such cleaning, thereby resolving the above-described undesirable effects associated with the combustion of silicon-containing compounds and enabling dramatic improvements in the operational ease and cost-effectiveness of the process.

Thus, when a liquid containing an element that forms a solid oxide by combustion is atomized and burned or flame hydrolyzed according to the present invention, the solid oxide does not readily deposit and build up on the burner itself, in the burner vicinity or inside the combustion furnace, thereby enabling stable and continuous long-term operation and making it possible to efficiently burn combustible liquids such as waste products containing silicon-bearing compounds.

### BRIEF DESCRIPTION OF THE DRAWINGS

FIG. 1 is a schematic view showing one embodiment of the burner according to the present invention.

FIG. 2 is a perspective view showing the main features of the same embodiment.

FIG. 3 is a partially cutaway, enlarged plan view of area A of the burner in FIG. 1.

FIG. 4 is a partially cutaway, plan view of another embodiment of the burner used in the invention.

FIG. 5 is a perspective view of a flame holder in the embodiment shown in FIG. 4.

FIG. 6 is a schematic view showing an embodiment of a combustion furnace according to the invention.

### BEST MODE FOR CARRYING OUT THE INVENTION

The invention is described more fully below in conjunction with the accompanying drawings with particular reference to the combustion of a liquid containing a silicon liquid. The invention provides a burner for the combustion of silicon-containing compounds that atomizes as liquid droplets, then burns or flame-hydrolyzes, a silicon-bearing compound-containing combustible liquid within a combustion furnace. The flame-generating burner main body has a circularly concentric multi-tube construction of at least three tubes comprising a central tube which emits a combustible liquid containing a silicon-bearing compound, and two or more outer tubes disposed concentrically outside the central tube which emit a combustion-supporting gas and/or a non-combustible gas. The burner is constructed such that the flame discharged from the central tube is covered by the gas jets emitted from the outer tubes, thereby restricting circulation and admixture of the flame with combustion gases within the furnace.

Combustible liquids that may be furnished for combustion herein include organic silicon compounds such as liquid silanes (e.g., tetramethoxysilane), siloxanes (e.g., hexamethyldisiloxane) or silazanes (e.g., hexamethyldisilazane), and silicone varnishes containing these liquid organic silicon compounds. Specific examples of liquids that may be furnished for combustion include silicone production equipment wash fluids, and distillation fractions and residues from silicone production.

Suitable examples of the combustion-supporting gas emitted from the outer tubes include air and oxygen. In the present case, dry air or oxygen is preferably emitted from the first outer tube concentrically surrounding the central tube which emits the above combustible liquid. Dry air or oxygen may also be emitted from the second outer tube surrounding the first outer tube, although the emission of ordinary air that has not been subjected to a drying operation suffices. In the present invention, there may be disposed outside of the second outer tube, with circular concentricity thereto, a third or yet additional outer tubes from which exits a combustion-supporting gas similar to that emitted from the second outer tube.

In addition, a burner tile may be disposed at a predetermined interval outside of the outer tubes so as to surround the outermost tube. A combustion-supporting gas such as air or oxygen may be emitted between the outermost tube and the burner tile.

A non-combustible gas such as nitrogen may be emitted together with, or even in place of, the combustion-supporting gas.

In a mechanical atomizing burner, the first outer tube preferably emits a combustion-supporting gas such as air or oxygen, and the second outer tube preferably emits a combustion-supporting gas or a non-combustible gas containing a combustion-supporting gas, although in some cases it may emit only a non-combustible gas.

In a twin-fluid atomizing burner, it is preferable for both the first and second outer tubes to emit a combustion-supporting gas or a non-combustible gas containing a combustion-supporting gas.

The velocity of gas emission from the first and second outer tubes is preferably from 1 to 250 m/s.

If a twin-fluid atomizing burner is employed, the velocity of gas emission from between the outermost tube and the burner tile is preferably from 5 to 100 m/s when air is used as the gas.

Any suitable technique may be used for atomizing the liquid in the central tube of the multi-tube burner, provided it has a mechanism for mixing the liquid with a gas to obtain a mist-like mixture of liquid droplets and gas. Examples of atomizing techniques that may be used include mechanical atomization, rotary atomization and twin-fluid atomization.

As is apparent from the above-described operative principle of the invention, in the present case, a silicon liquid is emitted from the central tube in the multi-tube burner, and the flame generated at this time must be covered by the jets of gas discharged from the outer tubes. When the silicon liquid is discharged from somewhere other than the central tube, such as from the first or second outer tube, the operative principle does not apply, and so the silicon dioxide formed by combustion readily deposits in the vicinity of the discharge orifices, making the burner unfit for practical use.

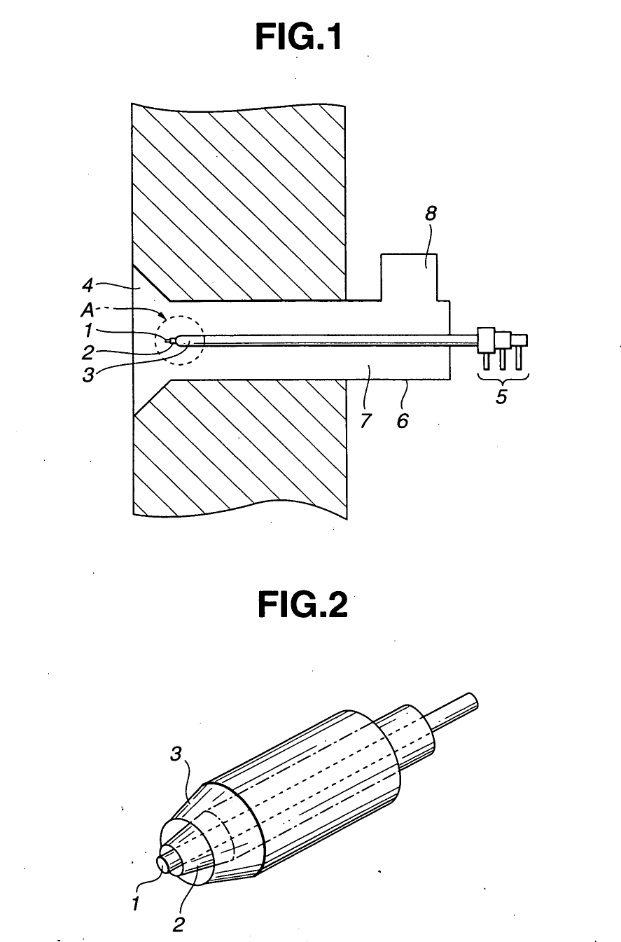

FIGS. 1 to 3 illustrate a specific embodiment of a burner according to the present invention in which the central tube for discharging a liquid is of an external-mixing twin-fluid atomizing configuration. The burner has a main body comprising a liquid-emitting central tube 1 in combination with first and second combustion-supporting gas and/or non-combustible gas-emitting outer tubes 2 and 3 disposed with circular concentricity outside of the central tube 1. The tip of the central tube 1 projects out beyond the tip of the inside outer tube 2, and the tip of the inside outer tube 2 projects out beyond the tip of the outside outer tube 3. The combustible liquid, the combustion-supporting gas such as air or oxygen, and/or the non-combustible gas such as nitrogen are each supplied to central tube 1 and outer tubes 2 and 3 from fluid feed ports 5.

The burner has a burner tile 4 disposed such as to surround the outside of the outermost tube 3. The tip of the burner main body is situated short of the face of the burner tile on the furnace interior side thereof. In this burner, air or the like is fed from an air inlet 8 to a flow passage 7 (between the burner tile 4 and the second outer tube 3) having a windbox 6.

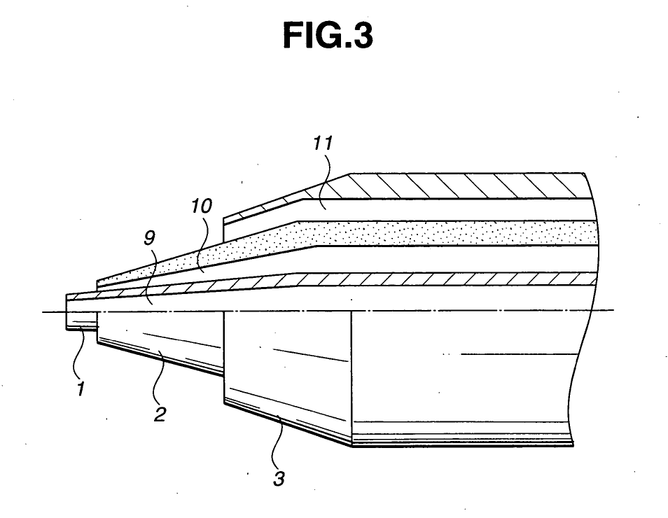

Referring to FIG. 3, which is a schematic partially cutaway view showing the tip portion of the multi-tube arrangement in the burner shown in FIG. 1, a combustible liquid passage 9 is formed within the central tube 1, and gas passages 10 and 11 are formed respectively in outer tubes 2 and 3.

The inventive burner depicted in FIGS. 1 to 3 has the following construction.

(1) The tubes making up the multi-tube arrangement are each disposed such that their respective tips are circularly concentric.

(2) The tips of each outer tube surrounding the atomizing area are preferably situated such that either the tip of the outside tube is stepped back from the tip of the inside tube, or the tip of each outer tube is coplanar with the tip of the atomizing region.

(3) Preferably, the tip portion of each tube is shaped such as to taper toward the tip, has a straight cylindrical shape or has a shape representing a combination thereof; that is, the shape is preferably not one which flares out toward the tip.

(4) The burner tile preferably has a shape which widens toward the inside of the combustion furnace, has parallel sides, or is a combination thereof.

(5) The tip portion of each tube preferably has a wall thickness which decreases toward the tip at an acute angle, remains constant, or has a shape that represents a combination thereof; that is, the wall thickness preferably does not increase toward the tip.

(6) The tip of the multi-tube arrangement is preferably situated such as to be either short of or coplanar with the face of the burner tile on the combustion furnace side; that is, it should preferably not jut out into the furnace.

In the practice of the invention, given the operative principle described earlier, it is preferable for the flow rate of combustion-supporting gas and non-combustible gas for covering the flame to be within a suitable range which is at least sufficient to shield the flame from combustion gases present within the combustion furnace, yet is not so excessive as to hinder combustion. Of course, to continuously maintain the flame and assure good combustion, it is necessary to feed the minimal amount of oxygen (stoichiometric amount) necessary for complete combustion of the combustible liquid.

Moreover, to suppress deposition of the S element oxide on the burner, in the burner vicinity, and especially near the discharge orifice, it is preferable for the velocity of the fluid emitted from each tube in the multi-tube arrangement to be regulated within a range in velocity which is at least sufficient to maintain good atomization yet not so excessive as to hinder combustion.

Specifically, the velocity of liquid emission from the central tube is preferably set at from 5 to 250 m/s, the velocity of gas emission from the first outer tube is preferably set at from 1 to 250 m/s, the velocity of gas emission from the second outer tube is preferably set at from 1 to 250 m/s, and the velocity of gas emission from between the outermost tube and the burner tile when air is used as the gas is preferably set at from 5 to 100 m/s. Also, the amount of combustion-supporting gas supplied between the outer tubes and the burner tile, relative to the substance being burned that is emitted from the central tube, is preferably 0.5 to 5.0 times the stoichiometric amount.

When combustion is carried out using the burner described above, the liquid is atomized by being emitted at the above-indicated velocity and a temperature and pressure below the boiling point and by emission of the combustion-supporting gas and/or non-combustible gas from the first outer tube at the above-indicated velocity and a temperature of 0 to 30° C. The resulting atomized mixture is burned, and the flame thus generated is covered, with the combustion-supporting gas and/or non-combustible gas emitted from the second and subsequent outer tubes and also from between the burner tile and the outermost tube. The temperature of the combustion-supporting gas and/or non-combustible gas emitted from the second and subsequent outer tubes and from between the burner tile and the outermost tube is preferably from 0 to 30° C.

A plurality of burners having the construction of the invention may be installed at the interior of a single burner tile. Moreover, the burner tile may be preheated to improve the fluidity of the combustible liquid and of the combustion-supporting gas and non-combustible gas supplied to the burner, as well as for other reasons, such as controlling combustion.

The combustion furnace of the invention has a cooling mechanism for maintaining the temperature at the inside walls thereof within a required range, and also has a mechanism for removing and eliminating solids that have deposited on the inside walls. This arrangement has a two-fold purpose. When the oxide that has formed from combustion at the above-described burner has deposited as a powder on the inside walls of the furnace, the oxide powder is kept at a temperature lower than its sintering temperature or melting point so as to maintain the powder in an easy-to-remove state. In addition, periodic operation of the removal mechanism serves to remove such deposits from the system while still in the form of a powder.

One effective mechanism for keeping the temperature of the furnace inside wall within the required range is to spray the inside of the furnace with water. Other methods that may be used to achieve the same end include the use of a furnace wall having a coolant-circulating construction such as a water-cooled wall, and methods involving the supply of cold air. One effective deposit-removing mechanism is a soot blower. Other methods that may be used include installing a movable scraper within the furnace, and passing spheres made of a heat-resistant material such as iron or ceramic along the inside surface of the furnace walls.

When burning silicon-containing compounds, for example, the surface temperature at the inside wall of the furnace is preferably held within a range of 200 to 1,000° C. To achieve complete combustion, a temperature of at least 500° C. at which spontaneous ignition of organic materials occurs is preferred. To completely prevent sintering of the silicon dioxide powder, it is preferable to set the temperature at not higher than 850° C., at which crystal modification from quartz to tridymite can be prevented.

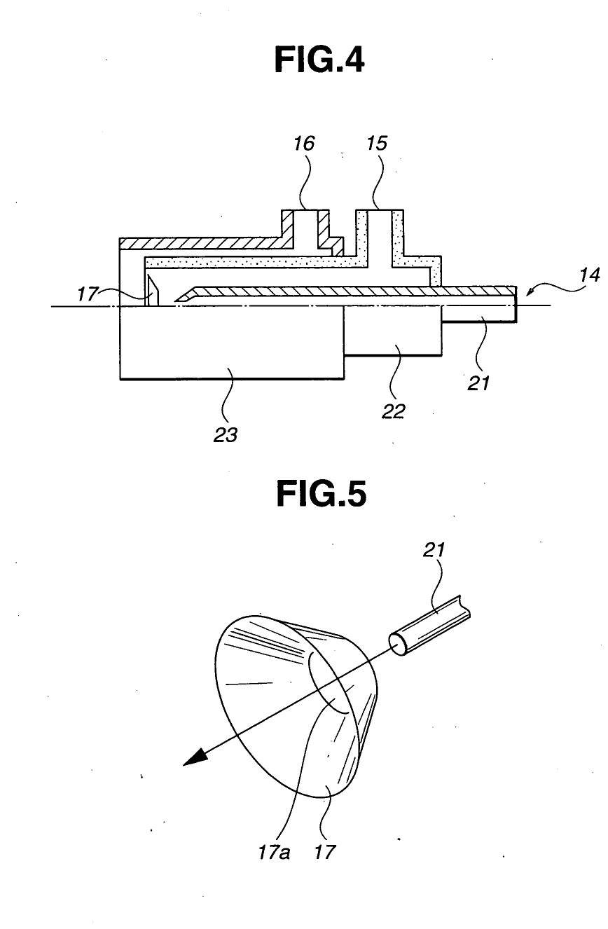

The burner in the combustion furnace of the invention may be an external-mixing twin-fluid atomizing burner like that shown in FIGS. 1 to 3, although use of the burner shown in FIG. 4 is also possible. FIG. 4 illustrates a burner according to the present invention in which the liquid emitting central tube has a pressure atomizing configuration, and the flame-generating burner main body has a circularly concentric multi-tube construction composed of three tubes. This burner main body has a liquid-emitting central tube 21, and first and second outer tubes 22 and 23, each of which emits a combustion-supporting gas or a combustion-supporting gas-containing non-combustible gas and is disposed concentrically outside of the central tube 21. A liquid is supplied to the central tube 21 from a combustible liquid feed port 14, and a combustion-supporting gas such as air or oxygen and/or a non-combustible gas such as nitrogen are supplied to the first and second outer tubes 22 and 23 from respective gas feed ports 15 and 16. A flame holder 17 is disposed inside the tip portion of the first outer tube 22 so as to be positioned in front of the central tube 21. The flame holder 17, as shown in FIG. 5, is shaped as a conical plate having an opening 17a at the center. If necessary, the plate may bear a plurality of holes, or may have a plurality of blades or projections thereon. The atomized mixture emitted from behind the flame holder 17 must pass through the opening 17a and emerge in front of the flame holder 17.

The pressure-atomizing burner of the invention shown in FIG. 4 has the following construction.

(1) Each tube in the multi-tube construction is disposed so that the respective tips are circularly concentric.

(2) Preferably, the tips of the respective tubes in the multi-tube construction are arranged such that outside tubes project further forward (in the direction of emission) than inside tubes, or the tips of the respective outer tubes are coplanar with the tip of the central tube.

(3) Preferably, the tip portion of each tube is shaped such as to taper toward the tip, has a straight cylindrical shape or has a shape representing a combination thereof; that is, the shape is preferably not one which flares out toward the tip.

(4) Preferably, the flame holder 17 is disposed forward of the central tube and at the interior of the outer tube tips, although it is possible not to include a flame holder if the flame has a high stability owing to such factors as the nature of the substance being burned and the furnace operating conditions.

(5) The tip portion of each tube preferably has a wall thickness which decreases toward the tip at an acute angle, remains constant, or has a shape that represents a combination thereof; that is, the wall thickness preferably does not increase toward the tip.

In this case as well, given the operative principle described above, it is preferable for the flow rate of combustion-supporting gas and/or non-combustible gas for covering the flame to be within a suitable range which is at least sufficient to shield the flame from combustion gases present within the combustion furnace, yet is not so excessive as to hinder combustion. Of course, to continuously maintain the flame and assure good combustion, it is necessary to feed the minimal amount of oxygen (stoichiometric amount) necessary for complete combustion of the combustible liquid.

Moreover, to suppress deposition of the S element oxide on the burner, in the burner vicinity, and especially near the discharge orifice, it is preferable for the velocity of the fluid emitted from each tube in the multi-tube arrangement to be regulated within a range in velocity which is at least sufficient to maintain good atomization yet not so excessive as to hinder combustion.

Specifically, the velocity of combustible liquid emission from the central tube is preferably set at from 5 to 250 m/s, and especially from 5 to 50 m/s in the case of pressure atomization. The velocity of gas emission from the first and second outer tubes is preferably set at from 5 to 50 m/s when air is used in a pressure-atomizing burner.

The amount of combustion-supporting gas supplied between the outer tubes and the burner tile, relative to the substance being burned that is emitted from the central tube, is preferably 0.5 to 5.0 times the stoichiometric amount. To hold the flame stable, it is even more preferable to set the amount of combustion-supporting agent at from 0.8 to 2.0 times the stoichiometric amount.

When combustion is carried out using the burner described above, the liquid is atomized by being emitted at the above-indicated velocity and a temperature and pressure below the boiling point and by emission of the combustion-supporting gas and/or non-combustible gas from the first outer tube at the above-indicated velocity and a temperature of 0 to 30° C. The resulting atomized mixture is burned, and the flame thus generated is covered, with the combustion-supporting gas and/or non-combustible gas emitted from the second and subsequent outer tubes and also from between the burner tile and the outermost tube. The temperature of the combustion-supporting gas and/or non-combustible gas emitted from the second and subsequent outer tubes and from between the burner tile and the outermost tube is preferably from 0 to 30° C.

A plurality of burners having the construction of the invention may be installed at the interior of a single burner tile. Moreover, the burner tile may be preheated to improve the fluidity of the combustible liquid and of the combustion-supporting gas and non-combustible gas supplied to the burner, as well as for other reasons, such as controlling combustion.

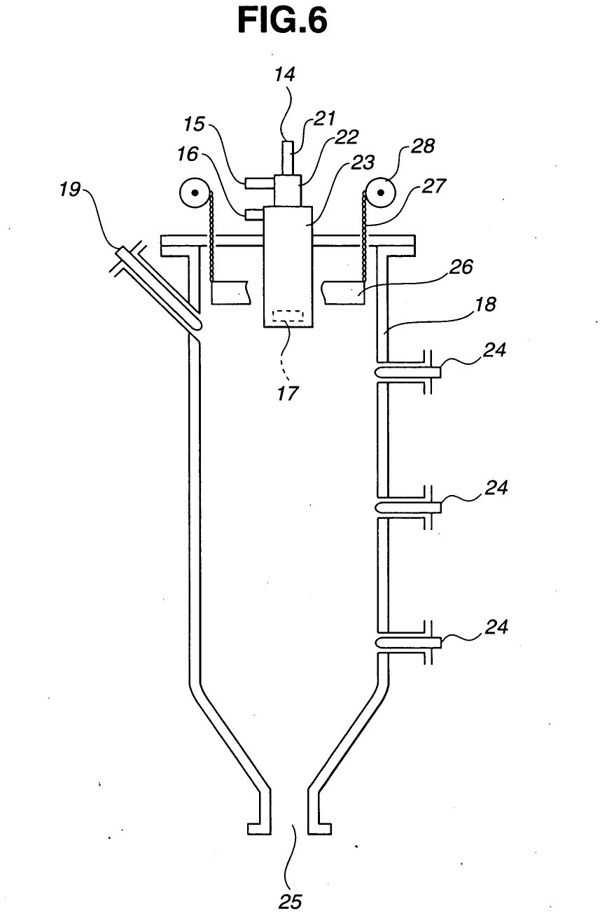

FIG. 6 illustrates an embodiment of a combustion furnace according to the present invention, and specifically a vertical cylindrical furnace having at the top a pressure-atomizing three-tube burner, a water-spraying nozzle for temperature regulation, and a movable scraper driving mechanism. The furnace is provided in a barrel portion thereof with soot blowers and a movable scraper. This combustion furnace has a furnace main body 18 in which there is disposed at the top thereof a burner like that shown in FIG. 4 comprising a central tube 21 and outer tubes 22 and 23. The burner supplies and ignites an S liquid and a combustion-supporting gas such as air or oxygen, thereby burning the S liquid and forming a solid oxide within the furnace main body 18. The furnace main body 18 is provided on a sidewall thereof with a water-spraying nozzle 19 for cooling. The nozzle 19 sprays water to allow combustion to continue while keeping the combustion temperature in the furnace main body 18 within a range where the S element oxide does not melt or sinter. In addition, soot blowers 24 are installed at suitable positions on the sidewall of the furnace main body 18 where S element oxide powder formed by combustion deposits and builds up. The soot blowers 24 are periodically operated at fixed intervals of time to knock down S element oxide powder from the furnace wall. The knocked down powder is discharged together with combustion gases from an exhaust opening 25 at the bottom of the furnace main body 18.

An annular movable scraper 26 is normally situated within the furnace main body 18 at the top thereof. The scraper 26 is coupled by a chain 27 to a drive mechanism 28 located outside of the furnace main body 18. Operation of the drive mechanism 28 causes the chain 27 to wind onto or play out from the drive mechanism 28, causing the scraper 26 to slide upward or downward along the inner peripheral wall surface of the furnace main body 18 so as to knock down any S element oxide powder that has deposited and built up on the walls of the furnace main body 18 and has not been removed by the soot blowers 24.

Although the embodiment of the inventive furnace shown in FIG. 6 is not provided with a burner tile, and is shaped to hold the flame using the burner and a flame holder, a burner tile may be provided in the manner described above. Temperature control within the illustrated furnace is carried out by a water spraying system but, as noted earlier, any suitable mechanism which maintains the inside wall surface at a temperature at which the S element oxide powder does not melt or sinter may be used. Illustrative examples include a direct cooling system such as water-cooled walls, and methods involving the supply of cold air. Also, even though the use of both soot blowers and a movable scraper has been described above as an example of a method for removing S element oxide from the inside walls, any other suitable method may be used without particular limitation so long as it is a mechanism which knocks down such powder from the inside surfaces of the furnace walls. Illustrative examples include a method in which heat-resistant spheres are dropped from the top of the furnace and a method that involves vibrating the entire furnace.

The type of furnace used in the present embodiment is a vertical cylindrical furnace which bums only liquids containing S element-bearing compounds. However, if the combustion furnace must also be fed other liquids and/or solids at the same time, use may be made of any suitable type of furnace, provided this has the mechanisms critical to the practice of the invention, as noted below.

The combustion furnace of the invention shown in FIG. 6 has a construction which includes the following features.

(1) A mechanism which keeps the temperature at the inside surface of the furnace wall lower than the melting point or sintering temperature of the S element oxide powder.

(2) A mechanism which removes S element oxide powder that has deposited and built up on the furnace inside walls, and discharges such powder from the system.

The following examples and comparative examples are provided to illustrate the invention, and are not intended to limit the scope thereof.

### EXAMPLE 1

Tetramethoxysilane was burned under the following conditions using a burner of the construction shown in FIGS. 1 to 3.

(1) Burner Shape

Central tube (stainless steel): bore, 8 mm; bore at discharge orifice, 4 mm

First outer tube (stainless steel): bore, 20 mm; bore at discharge orifice, 8 mm

Second outer tube (stainless steel): bore, 32 mm; bore at discharge orifice, 28 mm

(2) Fluid Emitted from Each Tube, and Emission Rate and Temperature

Central tube: tetramethoxysilane (200 kg/h), 20° C.

First outer tube: air (16 Nm³/h), 20° C.

Second outer tube: air (50 Nm³/h), 20° C.

Gap between second outer tube and burner tile: air (2,300 Nm³/h), 20° C.

(3) Results

When combustion was carried out under the above conditions, even after 1,000 hours of combustion, growth in silicon dioxide deposits was not observed at the tips of the respective tubes, on the inside surface of the burner tile or on the inside walls of the furnace surrounding the edges of the burner tile, thereby allowing stable combustion to be continued.

### COMPARATIVE EXAMPLE 1

Tetramethoxysilane combustion was carried out under the same conditions as in Example 1 using a burner which was similar but had a two-tube construction without a second outer tube.

When combustion was carried out under these conditions, growth in silicon dioxide deposits occurred in the following areas within 4 hours from the start of combustion:

(a) a region extending from about 2 mm in front to about 20 mm behind the tip of the multi-tube configuration

(b) a region extending from the edge of the burner tile to the furnace inside walls in the circumferential direction for about 400 mm, and backwards toward the interior for about 200 mm.

Combustion was continued in spite of this, whereupon growth in the deposition of silicon dioxide continued. Ten hours after the start of combustion, the tip of the multi-tube burner and the space in front of the burner became obstructed, as a result of which continuous combustion ceased to be maintained and the flame went out.

### COMPARATIVE EXAMPLE 2

Tetramethoxysilane gas obtained by vaporizing tetramethoxysilane with an evaporator was burned under the following conditions using the burner described in Comparative Example 1.

(1) Fluid Emitted from Each Tube, and Emission Rate and Temperature

Central tube: gaseous tetramethoxysilane (2.1 kg/h), 130° C.

First outer tube: air (1.0 Nm³/h), 20° C.

Gap between first outer tube and burner tile: air (17.0 Nm³/h), 20° C.

(2) Results

The combustion reaction was carried out under the above conditions, obtaining similar results as in Example 1. Silicon dioxide deposition did not occur, making it possible to continue stable combustion.

### EXAMPLE 2

Tetramethoxysilane (Si(OCH₃)₄) combustion was carried out under the following conditions using a burner of the construction shown in FIG. 4.

(1) Burner Shape

Central tube (stainless steel): bore, 4 mm; tip with pressure-atomizing configuration; bore at discharge orifice, 0.2 mm

First outer tube (stainless steel): bore, 45 mm

Second outer tube (stainless steel): bore, 54 mm

Flame holder (stainless steel): diameter of opening, 10 mm; outside diameter, 40 mm; central angle in cross-section, 160°

Distance between central tube tip and first outer tube tip: 10 mm

Distance between first outer tube tip and second outer tube tip: 3 mm

(2) Fluid Emitted from Each Tube, and Emission Rate and Temperature

Central tube: tetramethoxysilane (1.6 kg/h), 20° C.

First outer tube: dry air (14.5 Nm³/h), 20° C.

Second outer tube: air (9.7 Nm³/h), 20° C.

(3) Furnace Temperature

Top of furnace (300 mm from top end): 850° C.

Base of furnace (900 mm from top end): 550° C.

(4) Furnace Shape and Other Parameters

Barrel (stainless steel): inside diameter, 208 mm; length, 1,000 mm; wall thickness, 4 mm

Soot blowers (iron): total of 3 blowers, one each positioned 300 mm, 600 mm and 900 mm from top end of furnace

Scraping mechanism (iron): cylindrical, with outside diameter of 180 mm, height of 30 mm, and plate thickness of 5 mm; suspended from above by chains and vertically movable

Water-spraying nozzle for cooling (stainless steel): tip is positioned 200 mm from top end of furnace; has twin-fluid atomizing configuration at tip for spraying water

Soot blowing interval: every 20 minutes

Scraping interval: every 60 minutes

(5) Results

The following results were obtained from operation under the above conditions.

a) In the interval from the start of combustion to about 30 minutes, light deposition of silicon dioxide powder occurred on the burner and in its vicinity ( on the surface of flame holder, at the tips of the first and second outer tubes (both having wall thicknesses of 2 mm), and on the outside of the second outer tube), as well as in the barrel portion of the furnace about 500 mm from the top of the furnace.

b) When furnace operation was continued for another 10 hours, the silicon dioxide which had deposited on the burner and in its vicinity flaked off under its own weight above a given thickness, and deposits on the inside walls of the furnace were kept from growing above a given thickness by periodic activation of the soot blowers and scraper. It was thus possible to maintain good combustion.

c) Combustion was stopped after 10 hours, following which the furnace was taken apart and inspected. The silicon dioxide inside the furnace retained the properties of a fine powder, from which it was confirmed that melting and sintering did not arise.

### COMPARATIVE EXAMPLE 3

Tetramethoxysilane combustion was carried out under the same conditions as in Example 2 using a burner which was similar but had a two-tube construction without a second outer tube.

When the combustion reaction was carried out under these conditions, silicon dioxide powder continued to settle onto the surface of the flame holder and onto the outside and tip of the first outer tube for as long as combustion continued. After about 2 hours, the surface of the flame holder and the front of the first outer tube became almost entirely obstructed by silicon dioxide, at which point combustion could no longer be continued.

1. An external-mixing twin-fluid atomizing burner which prevents obstruction by combustion products and has a circularly concentric multi-tube construction of three or more tubes, comprising:
a central tube which emits a liquid containing a chemical element that forms a solid oxide by combustion or flame hydrolysis,
a first outer tube which is disposed concentrically outside the central tube and emits a combustion-supporting gas and/or a non-combustible gas,
a second outer tube which is disposed concentrically outside the first outer tube and emits a combustion-supporting gas and/or a non-combustible gas, and optionally,
a passage which is disposed outside the second outer tube and supplies a combustion-supporting gas and/or a non-combustible gas;
wherein the tips of each outer tube surrounding the central tube are situated such that either tip of the outside tubes is stepped back from the tip of the inside tube; and the liquid emitted from the central tube is atomized and burned by the combustion-supporting gases and/or non-combustible gases supplied from the outer tubes and the optional passage disposed outside thereof, and
the flame thereby generated is covered by the combustion-supporting gases and/or non-combustible gases supplied from the outer tubes and the optional passage disposed outside thereof.

2. A burner of claim 1, wherein the chemical element that forms a solid oxide by combustion or flame hydrolysis is an element from group 1A other than hydrogen, group 2A, group 3B, group 4B, group 5B, group 6B, group 7B, group 8, group 1B, group 2B, group 3A, group 4A other than carbon, group 5A other than nitrogen, or group 6A other than oxygen and sulfur of the CAS version of the long-form periodic table of the elements.

3. A burner of claim 2, wherein the chemical element that forms a solid oxide by combustion or flame hydrolysis is silicon.

4. A burner of claim 3, wherein the chemical element that forms a solid oxide by combustion or flame hydrolysis is silicon, the velocity of liquid emission from the central tube is 5 to 250 m/s, the velocity of gas emission from the first outer tube is 1 to 250 m/s, the velocity of gas emission from the second outer tube is 1 to 250 m/s, a burner tile is provided outside of the second outer tube, and the amount of combustion-supporting gases relative to the substance being burned is 0.5 to 5.0 times the stoichiometric amount.

5. A combustion process for atomizing and burning or flame-hydrolyzing within a combustion furnace a liquid containing a chemical element that forms a solid oxide by combustion or flame hydrolysis, with the burner of claim 1, comprising
emitting the liquid from the central tube,
carrying out combustion with the combustion-supporting gases and/or non-combustible gases emitted from the concentric outer tubes disposed outside the central tube and also emitted from the optional passage disposed outside the outer tubes, and
covering the flame thereby generated with the combustion-supporting gases and/or non-combustible gases supplied from the outer tubes and also supplied from the optional passage disposed outside the outer tubes.

6. A combustion process of claim 5, wherein the chemical element that forms a solid oxide by combustion or flame hydrolysis is an element from group 1A other than hydrogen, group 2A, group 3B, group 4B, group 5B, group 6B, group 7B, group 8, group 1B, group 2B, group 3A, group 4A other than carbon, group 5A other than nitrogen, or group 6A other than oxygen and sulfur of the CAS version of the long-form periodic table of the elements.

7. A combustion process of claim 6, wherein the chemical element that forms a solid oxide by combustion or flame hydrolysis is silicon.

8. A combustion furnace comprising:
an external-mixing twin-fluid atomizing burner which prevents obstruction by combustion products and has a circularly concentric multi-tube construction of three or more tubes, comprised of
a central tube which emits a liquid containing a chemical element that forms a solid oxide by combustion or flame hydrolysis,
a first outer tube which is disposed concentrically outside the central tube and emits a combustion-supporting gas and/or a non-combustible gas,
a second outer tube which is disposed concentrically outside the first outer tube and emits a combustion-supporting gas and/or a non-combustible gas, and optionally
a passage which is disposed outside of the second outer tube and supplies a combustion-supporting gas and/or a non-combustible gas,
wherein the tips of each outer tube surrounding the central tube are situated such that either tip of the outside tubes is stepped back from the tip of the inside tube; and the liquid emitted from the central tube is atomized and burned by the combustion-supporting gases and/or a non-combustible gases supplied from the outer tubes and the optional passage disposed outside thereof, and the flame generated is covered by the combustion-supporting gases and/or a non-combustible gases supplied from the outer tubes and the optional passage disposed outside thereof;
a mechanism which holds the surface temperature on an inside wall of the furnace or the surface temperature of solid oxide deposits on the furnace inside wall lower than the melting point or sticking temperature of the solid oxide; and/or
a mechanism which can remove solid oxide deposits from the inside wall of the furnace.

9. A combustion furnace of claim 8, wherein the chemical element that forms a solid oxide by combustion or flame hydrolysis is an element from group 1A other than hydrogen, group 2A, group 3B, group 4B, group 5B, group 6B, group 7B, group 8, group 1B, group 2B, group 3A, group 4A other than carbon, group 5A other than nitrogen, or group 6A other than oxygen and sulfur of the CAS version of the long-form periodic table of the elements.

10. A combustion furnace of claim 9, wherein the chemical element that forms a solid oxide by combustion or flame hydrolysis is silicon.

11. A combustion furnace of claim 8, wherein the chemical element that forms a solid oxide by combustion or flame hydrolysis is silicon; the burner is configured such that the central tube has an atomizing mechanism at the tip thereof, each outer tube concentrically surrounding the central tube has a tip that is coplanar with the tip of the central tube or projects forward therefrom and optionally, a flame holder is disposed in front of the central tube; and the velocity of liquid emission from the central tube of 5 to 250 m/s, the velocity of gas emission from the first and second outer tubes is 1 to 250 m/s, and the amount of combustion-supporting gases relative to the substance being burned is 0.5 to 5.0 times the stoichiometric amount.

12. A combustion furnace of claim 11, further comprising a mechanism that holds the surface temperature on the inside wall of the furnace at from 200 to 1,000° C. and/or a mechanism that can remove solid oxide deposits from the inside wall of the furnace.

13. A combustion process for atomizing and burning or flame hydrolyzing within a combustion furnace a liquid containing a chemical element that forms a solid oxide by combustion or flame hydrolysis, comprising:
emitting the liquid from a central tube,
carrying out atomization and combustion with combustion-supporting gases and/or non-combustible gases emitted from outer tubes disposed concentrically outside the central tube and also emitted from an optional passage disposed outside the outer tubes;
covering the flame thereby generated with the combustion-supporting gases and/or non-combustible gases supplied from the outer tubes and also supplied from the optional passage disposed outside the outer tubes; and
carrying out treatment to hold the surface temperature at an inside wall of the combustion furnace below the melting point or sticking temperature of the solid oxide and/or carrying out treatment to remove solid oxide deposits from the inside wall of the furnace.

14. A combustion process of claim 13, wherein the chemical element that forms a solid oxide by combustion or flame hydrolysis is an element from group 1A other than hydrogen, group 2A, group 3B, group 4B, group 5B, group 6B, group 7B, group 8, group 1B, group 2B, group 3A, group 4A other than carbon, group 5A other than nitrogen, or group 6A other than oxygen and sulfur of the CAS version of the long-form periodic table of the elements.

15. A combustion process of claim 14, wherein the chemical element that forms a solid oxide by combustion or flame hydrolysis is silicon, and the surface temperature on the inside wall of the furnace or the surface temperature of solid oxide deposits on the furnace inside wall is held at from 200 to 1,000° C.

16. A burner of claim 1, wherein the tip portion of each tube is shaped such as to taper toward the tip, has a straight cylindrical shape or has a shape representing a combination thereof.

17. A burner of claim 1, wherein the tip portion of each tube has a wall thickness which decreases toward the tip at an acute angle, remains constant, or has a shape that represents a combination thereof.

18. A burner of claim 8, wherein the tip portion of each tube is shaped with a taper toward the tip, a straight cylindrical shape or a shape representing a combination thereof.

19. A furnace of claim 8, wherein the tip portion of each tube comprises a wall thickness which decreases toward the tip at an acute angle, remains constant, or comprises a shape that represents a combination thereof.

20. A combustion furnace comprising:
a pressure-atomizing burner which prevents obstruction by combustion products and comprises a circularly concentric multi-tube construction of three or more tubes comprising:
a central tube for emitting a liquid containing a chemical element that forms a solid oxide by combustion or flame hydrolysis,
a first outer tube which is disposed concentrically outside the central tube and emits a combustion-supporting gas and/or a non-combustible gas,
a second outer tube which is disposed concentrically outside the first outer tube and emits a combustion-supporting gas and/or a non-combustible gas, and optionally, a passage which is disposed outside the second outer tube and supplies a combustion-supporting gas and/or a non-combustible gas;
each tube being arranged such that the first outer tube projects further forward than the central tube and the second outer tube projects further forward than the first outer tube, and a tip portion of each tube is shaped with a taper reducing its diameter toward the tip;
wherein the liquid emitted from the central tube is atomized and burned and the flame generated is covered by a combustion-supporting gas and/or non-combustible gas jet supplied from the outer tubes and the optional passage disposed outside thereof;
a mechanism which holds the surface temperature on an inside wall of the furnace or the surface temperature of solid oxide deposits on the furnace inside wall lower than the melting point or sticking temperature of the solid oxide; and
an annular movable scrapper.

21. A burner which prevents obstruction by combustion products and has a circularly concentric multi-tube construction of three or more tubes, consisting essentially of:
a central tube which emits a liquid containing a chemical element that forms a solid oxide by combustion or flame hydrolysis,
a first outer tube which is disposed concentrically outside the central tube and emits a combustion-supporting gas and/or a non-combustible gas,
a second outer tube which is disposed concentrically outside the first outer tube and emits a combustion-supporting gas and/or a non-combustible gas, and optionally, a passage which is disposed outside the second outer tube and supplies a combustion-supporting gas and/or a non-combustible gas;
wherein the liquid emitted from the central tube is atomized and burned by the combustion-supporting gases and/or non-combustible gases supplied from the outer tubes and the optional passage disposed outside thereof, and the flame thereby generated is covered by the combustion-supporting gases and/or non-combustible gases supplied from the outer tubes and the optional passage disposed outside thereof.

22. A combustion furnace comprising:
a pressure-atomizing burner which prevents obstruction by combustion products and comprises a circularly concentric multi-tube construction of three or more tubes comprising:
a central tube for emitting a liquid containing a chemical element that forms a solid oxide by combustion or flame hydrolysis,
a first outer tube which is disposed concentrically outside the central tube and emits a combustion-supporting gas and/or a non-combustible gas,
a second outer tube which is disposed concentrically outside the first outer tube and emits a combustion-supporting gas and/or a non-combustible gas, and optionally, a passage which is disposed outside the second outer tube and supplies a combustion-supporting gas and/or a non-combustible gas;
each tube being arranged such that the first outer tube projects further forward than the central tube and the second outer tube projects further forward than the first outer tube, and a tip portion of each tube is shaped with a taper reducing its diameter toward the tip;
wherein the liquid emitted from the central tube is atomized and burned and the flame generated is covered by a combustion-supporting gas and/or non-combustible gas jet supplied from the outer tubes and the optional passage disposed outside thereof;
a mechanism which holds the surface temperature on an inside wall of the furnace or the surface temperature of solid oxide deposits on the furnace inside wall lower than the melting point or sticking temperature of the solid oxide; and
a mechanism which can remove solid oxide deposits during stable and continuous combustion from the inside wall of the furnace.

23. A combustion furnace comprising:
a pressure-atomizing burner which prevents obstruction by combustion products and comprises a circularly concentric multi-tube construction of three or more tubes comprising:
a central tube for emitting a liquid containing a chemical element that forms a solid oxide by combustion or flame hydrolysis,
a first outer tube which is disposed concentrically outside the central tube and emits a combustion-supporting gas and/or a non-combustible gas,
a second outer tube which is disposed concentrically outside the first outer tube and emits a combustion-supporting gas and/or a non-combustible gas, and optionally, a passage which is disposed outside the second outer tube and supplies a combustion-supporting gas and/or a non-combustible gas;
each tube being arranged such that the first outer tube projects further forward than the central tube and the second outer tube projects further forward than the first outer tube, and the tip portion of each tube is shaped with a taper toward the tip;
wherein the liquid emitted from the central tube is atomized and burned and the flame generated is covered by a combustion-supporting gas and/or non-combustible gas jet supplied from the outer tubes and the optional passage disposed outside thereof;
a mechanism which holds the surface temperature on an inside wall of the furnace or the surface temperature of solid oxide deposits on the furnace inside wall lower than the melting point or sticking temperature of the solid oxide;
a mechanism which can remove solid oxide deposits from the inside wall of the furnace; and
a flame holder disposed in front of the central tube and at the interior of the forwardly-projecting outer tube tips.

24. A combustion furnace comprising a main body having a top and an exhaust opening at the bottom of the main body, comprising:
a pressure-atomizing burner at the top of the main body which prevents obstruction by combustion products and comprises a circularly concentric multi-tube construction of three or more tubes comprising:
a central tube for emitting a liquid containing a chemical element that forms a solid oxide by combustion or flame hydrolysis,
a first outer tube which is disposed concentrically outside the central tube and formed at least partially integrally therewith and emits a combustion-supporting gas and/or a non-combustible gas,
a second outer tube which is disposed concentrically outside the first outer tube and formed at least partially integrally therewith and emits a combustion-supporting gas and/or a non-combustible gas, and optionally, a passage which is disposed outside the second outer tube and supplies a combustion-supporting gas and/or a non-combustible gas;
each tube being arranged such that the first outer tube projects further forward than the central tube and the second outer tube projects further forward than the first outer tube, and the tip portion of each tube is shaped with a taper toward the tip;
wherein the liquid emitted from the central tube is atomized and burned and the flame generated is covered by a combustion-supporting gas and/or non-combustible gas jet supplied from the outer tubes and the optional passage disposed outside thereof;
a mechanism which holds the surface temperature on an inside wall of the furnace or the surface temperature of solid oxide deposits on the furnace inside wall lower than the melting point or sticking temperature of the solid oxide; and
a mechanism which can remove solid oxide deposits from the inside wall of the furnace.

25. A furnace according to claim 24, wherein the mechanism which can remove solid oxide deposits is an annular movable scraper.

26. A furnace according to claim 25, further comprising a drive mechanism located outside of the main body coupled by a chain to the annular movable scraper.

27. A furnace according to claim 20, further comprising a drive mechanism located outside of the main body coupled by a chain to the annular movable scraper.

28. A furnace according to claim 22, wherein the first outer tube provides a combustion supporting gas.

29. A furnace according to claim 23, wherein the first outer tube provides a combustion gas.

30. A furnace according to claim 24, wherein the first outer tube provides a combustion gas.
